(19) United States
(12) Patent Application Publication
(10) Pub. No.: US 2019/0392095 A1
(43) Pub. Date: Dec. 26, 2019

(54) INTER-ARTIFACT GENERATION FOR INTERFACES OF A MODELED SYSTEM

(71) Applicant: Siemens Product Lifecycle Management Software Inc., Plano, TX (US)

(72) Inventors: Jason Wickers, Gig Harbor, WA (US); Manoj Vazarkar, Pune (IN); Krishnan Srinivasan, Austin, TX (US); Vinayak Pharande, Pune (IN); Abraham George, Loveland, OH (US)

(21) Appl. No.: 16/482,114

(22) PCT Filed: May 8, 2018
(86) PCT No.: PCT/US2018/031544

§ 371 Date: Jul. 30, 2019

(30) Foreign Application Priority Data
May 8, 2017 (IN) 201711016165

(51) Int. Cl. G06F 17/50

(52) U.S. Cl. CPC G06F 17/5009; G06F 17/5095

(57) ABSTRACT

Systems and methods may support inter-artifact generation for interfaces of a modeled system. In some implementations, a system may include an inter-artifact model repository that stores system model data of a model system as well as an artifact extraction engine configured to extract system model data from a system artifact that represents the modeled system and store the extracted system model data in the inter-artifact model repository. The system may further include an artifact generation engine configured to generate a different system artifact that represents the modeled system using at least some of the extracted system model data extracted from the system artifact.

### CROSS REFERENCE TO RELATED APPLICATION

This application claims the benefit of priority to Indian Patent Application No. 201711016165, filed on May 8, 2017 as a provisional patent application with the Indian Patent Office and titled “SYSTEM AND METHOD FOR INTEGRATED INTERFACE ANALYSIS”, which is incorporated herein by reference in its entirety.

### BACKGROUND

Computer systems can be used to create, use, and manage data for products and other items. Examples of computer systems include computer-aided engineering (CAE) systems, computer-aided design (CAD) systems, visualization and manufacturing systems, product data management (PDM) systems, product lifecycle management (PLM) systems, modeling systems and more. These systems may include components that facilitate design and simulated testing of products.

### SUMMARY

Disclosed implementations include systems, methods, devices, and logic that may support inter-artifact generation for interfaces of a modeled system.

In one example, a method may be performed, executed, or otherwise carried out by a computer system, such as a CAD, CAE, or CAM system. The method may include extracting system model data from a system artifact that represents a modeled system and storing the extracted system model data in an inter-artifact model repository. Such storing may include storing interface elements that specify communication characteristics for system objects of the modeled system, interactions that represent a connection between system blocks of the modeled system, and exchange elements that specify particular functions and values communicated through the interactions. The method may further include generating a different system artifact that represents the modeled system using at least some of the extracted system model data extracted from the system artifact.

In another example, a system may include an inter-artifact model repository, an artifact extraction engine, and an artifact generation engine. The inter-artifact model repository may store system model data of a modeled system, including interface elements that specify communication characteristics for system objects of the modeled system, interactions that represent a connection between system blocks of the modeled system, and exchange elements that specify particular functions and values communicated through the interactions. The artifact extraction engine may be configured to extract system model data from a system artifact that represents the modeled system and store the extracted system model data in the inter-artifact model repository. The artifact generation engine may be configured to generate a different system artifact that represents the modeled system using at least some of the extracted system model data extracted from the system artifact.

In yet another example, a non-transitory machine-readable medium may store processor-executable instructions. When executed, the instructions may cause a system to extract system model data from a system artifact that represents a modeled system and store the extracted system model data in an inter-artifact model repository, including storage of interface elements that specify communication characteristics for system objects of the modeled system, interactions that represent a connection between system blocks of the modeled system, and exchange elements that specify particular functions and values communicated through the interactions. Execution of the processor-executable instructions may further cause the system to generate a different system artifact that represents the modeled system using at least some of the extracted system model data extracted from the system artifact.

### BRIEF DESCRIPTION OF THE DRAWINGS

Certain examples are described in the following detailed description and in reference to the drawings.

FIG. 1 shows an example of a system that supports inter-artifact generation for interfaces of a modeled system.

FIG. 2 shows an example of system model data extraction by an artifact extraction engine.

FIG. 3 shows an example of inter-artifact generation.

FIG. 4 shows an example of inter-artifact generation based on a user-selected section of an artifact.

FIG. 5 shows an example of logic that a system may implement to support inter-artifact generation for interfaces of a modeled system.

FIG. 6 shows an example of a system that supports inter-artifact generation for interfaces of a modeled system.

### DETAILED DESCRIPTION

The present disclosure relates to systems engineering, which may refer to techniques and processes to design and manage systems across various points of a system lifecycle. Systems engineering techniques are used across nearly every facet of modern society, from the design of automobile engine architectures, weather satellites, cellular networks, mobile devices, building infrastructures, medical equipment, and countless other systems prevalent amongst even common objects today. As modern technological capabilities grow, the complexity of such systems modeled through systems engineering tools increases, and some modeled systems may have thousands or millions of subsystems and components, possibly more.

Systems engineering may utilize various artifacts to support modeling and design. As used herein, an artifact may refer to any product, data structure, or other information object that describes the function, architecture, or design of a model system (or subsystems or components thereof). As many present systems modeling techniques require a systems engineer to model at a granular level, artifacts may be provided at a class level, focusing on represented system entities and relationships between such entities as added by a user on a per-entity basis. As these artifacts may be individually designed through localized workstations or environments, system artifacts are typically disparate and difficult to manage over a system lifecycle.

The features described herein may provide system integration mechanisms such that different system artifacts may be consistently generated from common inter-artifact data extracted and stored for a modeled system. In particular, the features described herein may provide for inter-artifact generation, which may refer to data extraction from a first system artifact to support generation of a second artifact for a modeled system. As such, the features described herein may support consistent generation of multiple, different artifacts from system model data extracted and stored in an inter-artifact model repository and provide mechanisms to flexibly swap between different representations of modeled systems through inter-artifact generation.

In particular implementations, the features described herein may extract system model data applicable to interfaces between various system components (also referred to herein as system blocks) and use the extracted system model data to flexibly generate various interface artifacts with increased accuracy and efficiency. System model data may refer to any data representative of or applicable to a modeled system. The features described herein may reduce or remove the need for manual generation of system artifacts by systems engineers, and accordingly may reduce human error and allow for consistent, accurate, and complete population of generated artifacts. These, and other inter-artifact generation features are described in greater detail herein.

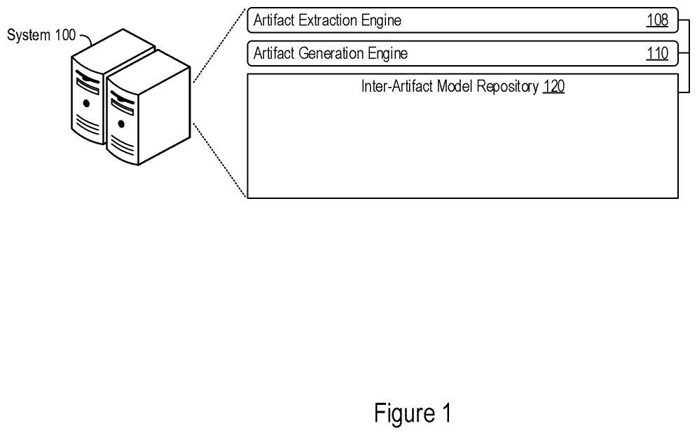

FIG. 1 shows an example of a system that supports inter-artifact generation for interfaces of a modeled system. The system 100 may take the form of a computing system, including a single or multiple computing devices such as application servers, compute nodes, desktop or laptop computers, smart phones or other mobile devices, tablet devices, embedded controllers, and more. The system 100 may support extraction of system model data from a user-generated artifact, storing the extracted system model data in a common content repository that can be used to consistently generate other artifacts for the visualization of system model data. In that regard, the system 100 may support inter-artifact generation by supporting data extraction from an artifact to support generation of another artifact for a modeled system.

As an example implementation, the system 100 shown in FIG. 1 includes an artifact extraction engine 108 and an artifact generation engine 110 that may support robotic simulations in various ways. The system 100 may implement the engines 108 and 110 (and components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the system 100 implements multiple engine components or system elements using the same computing system features or hardware components (e.g., a common processor and common storage medium).

The example system 100 shown in FIG. 1 also includes an inter-artifact model repository 120. As described in greater detail below, the inter-artifact model repository 120 may store system model data, for example as extracted from a particular artifact of a modeled system. The system 100 may implement the inter-artifact model repository 120 as any suitable data structure, for example as a relational database, lookup table, or other data structure stored on a non-transitory machine-readable medium.

In operation, the artifact extraction engine 108 may extract system model data from a system artifact that represents a modeled system and store the extracted system model data in the inter-artifact model repository 120. In some implementations, the artifact extraction engine 108 extracts and stores interface elements that specify communication characteristics for system objects of the modeled system, interactions that represent a connection between system blocks of the modeled system, and exchange elements that specify particular functions and values communicated through the interactions.

In operation, the artifact generation engine 110 may generate a different system artifact that represents the modeled system using at least some of the extracted system model data extracted from the system artifact.

These and other inter-artifact generation features are described in greater detail next. While some examples are present in the Figures and description herein, a system may additionally or alternatively implement any of the various features described in Indian Patent Application No. 201711016165, from which the present disclosure claims priority. For instance, a system may implement any of the features described in Indian Patent Application No. 201711016165 in combination with the features described herein, for example via the artifact extraction engine 108, the artifact generation engine 110, or a combination of both.

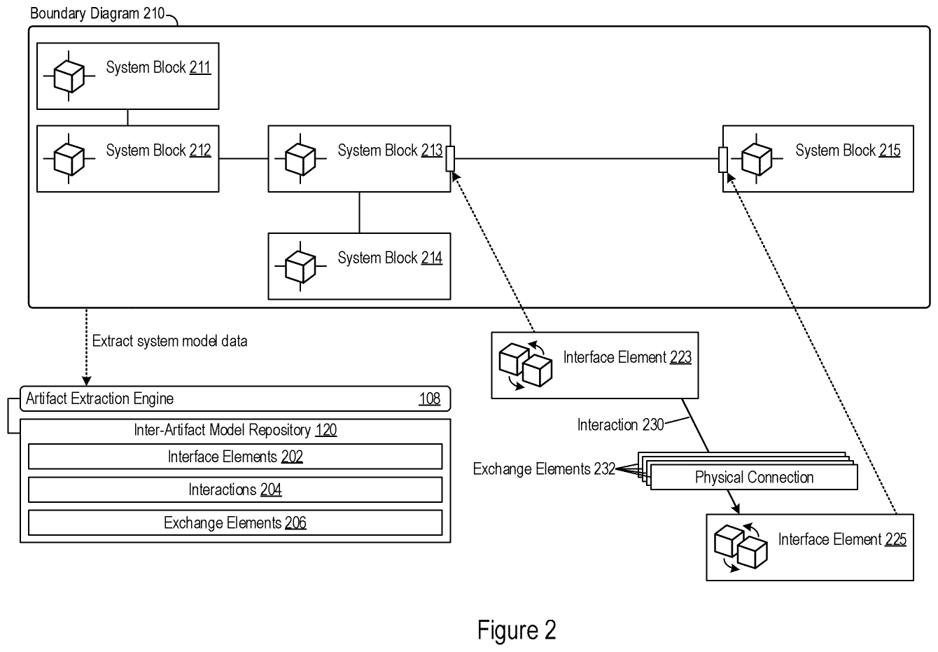

FIG. 2 shows an example of system model data extraction by the artifact extraction engine 108. The artifact extraction engine 108 may extract system model data from an artifact to store in the inter-artifact model repository 120. In some implementations, the artifact extraction engine 108 may extract selected system model data from an artifact and the particular system model data extracted may vary based on the class, characteristics, or attributes of inter-artifact content stored by the inter-artifact model repository 120. For instance, many of the examples described herein relate to interfaces through which various system components (e.g., subsystems or system entities) are linked, communicate, or are otherwise inter-related. And while many of the examples herein are presented specifically for interface-specific artifacts and common system model data used for inter-artifact generation of such interface-specific artifacts, the features described herein may be consistently implemented and applied for inter-artifact generation for system model data of any type.

Examples of interface-specific system model data include physical, material, energy, and/or information (PMEI) interactions between system components. Some examples of interface artifacts include boundary diagrams, interface matrices, and interface tables. A boundary diagram may provide a diagram format to visualize interconnections between various system components, for example as line connections between system blocks. The lined interconnections of a boundary diagram may represent one or more PMEI interactions between linked system blocks. An interface matrix may specify system component dependencies with respect to PMEI interactions in a modeled system in matrix form, e.g., through multiple matrix cells of a two-dimensional matrix. An interface table may display and enable a user to specify required functions or provide other description for PMEI interactions of a modeled system, doing so in table form that may include separate rows for individual PMEI interactions between system components.

In the example shown in FIG. 2, the artifact extraction engine 108 extracts system model data in the form of interface elements 202, interactions 204, and exchange elements 208, and does so from an artifact in the form of a boundary diagram 210. The boundary diagram 210 shown in FIG. 2 includes the system blocks 211-215 and various connections between the depicted system blocks 211-215. A user may create or edit the boundary diagram 210 to model a system, for example through individual insertion of the system blocks 211-215 and manual insertion of links between various system components. The artifact extraction engine 108 may extract system model data (e.g., as input or modified by a user) from the boundary diagram 210 for subsequent artifact generation.

In extracting system model data from the boundary diagram 210, the artifact extraction engine 108 may specifically identify and pull interface-related data from the boundary diagram 210 to support generation of other interface artifacts, such as an interface matrix or an interface table. Some examples of extracted system model data (e.g., interface elements 202, interactions 204, and exchange elements 206) that the artifact extraction engine 108 may extract from the boundary diagram 210 are illustrated in FIG. 2 through the interfaces and link between system blocks 213 and 215.

The artifact extraction engine 108 may extract interface elements 202 from a system artifact. As noted above, interface elements 202 may specify communication characteristics for system objects of a modeled system. For instance, an interface element 202 may correlate to a particular port of a system block, and define a set of eventual interactions for the system block. Interface elements 202 may thus store data that captures the behavior (e.g., flow direction) of PMEI interactions of system block ports. Such tracked data of interface elements 202 may include properties of a system block port, such as a subject (e.g., supported PMEI interaction types), directional data, function data, effect data, measurable attribute data, and the like.

In the example shown in FIG. 2, the artifact extraction engine 108 extracts the interface element 223 (of the system block 213) and the interface element 225 (of the system block 215) from the boundary diagram 210 as selected system model data to store in the inter-artifact model repository 120.

As another example of selected system model data, the artifact extraction engine 108 may extract interactions 204 from a system artifact, such as the boundary diagram 210. Interactions 204 may represent an actual interconnection (e.g., communication or link) between system blocks of the modeled system. In that regard, interactions 204 may be user-specified as part of a system design process. An interaction 204 may include one or more interactions types (e.g., any number of PMEI interactions) as well as any other information applicable to an inter-relation between system blocks (e.g. interaction descriptions, etc.)

With regards to PMEI interactions, a physical interaction may correspond to a specific physical interconnection or orientation between system blocks. A material interaction may correspond to a specified material exchange between system blocks. An energy interaction may correspond to an energy transfer/exchange between system blocks. An information interaction may correspond to a data or signal exchange between system blocks. While PMEI interactions are various interaction formats that an interaction 204 may include, various other interactions are contemplated and can be consistently supported by the inter-artifact generation features described herein.

In the example shown in FIG. 2, the artifact extraction engine 108 extracts the interaction 230 between the system blocks 213 and 215 as selected system model data to store in the inter-artifact model repository 120.

As yet another example of selected system model data, the artifact extraction engine 108 may extract exchange elements 206 from a system artifact. Exchange elements 206 may specify particular functions and values exchanged through interactions 204. As such, exchange elements 206 may provide the actual PMEI values and functions that are communicated between system blocks or by which the system blocks are inter-related. In the example shown FIG. 2, the artifact extraction engine 108 extracts the exchange elements 232 from the boundary diagram 210 as selected system model data to store in the inter-artifact model repository 120, which may include specific PMEI values/functions by which system blocks 213 and 215 are inter-related.

By extracting such selected system model data, the artifact extraction engine 108 may support inter-artifact generation. Use of the inter-artifact model repository 120 as a common data source may provide an integrated mechanism by which system model data may be consistently stored and accessed for artifact generation. As noted above, the artifact extraction engine 108 may selectively extract system model data from a system artifact (e.g., a boundary diagram 210), which may increase system efficiency and reduce communication latencies by pulling applicable inter-artifact data (without unnecessarily loading or pulling other unrelated data from a system artifact). As such, the artifact extraction engine 108 may support inter-artifact generation for modeled systems.

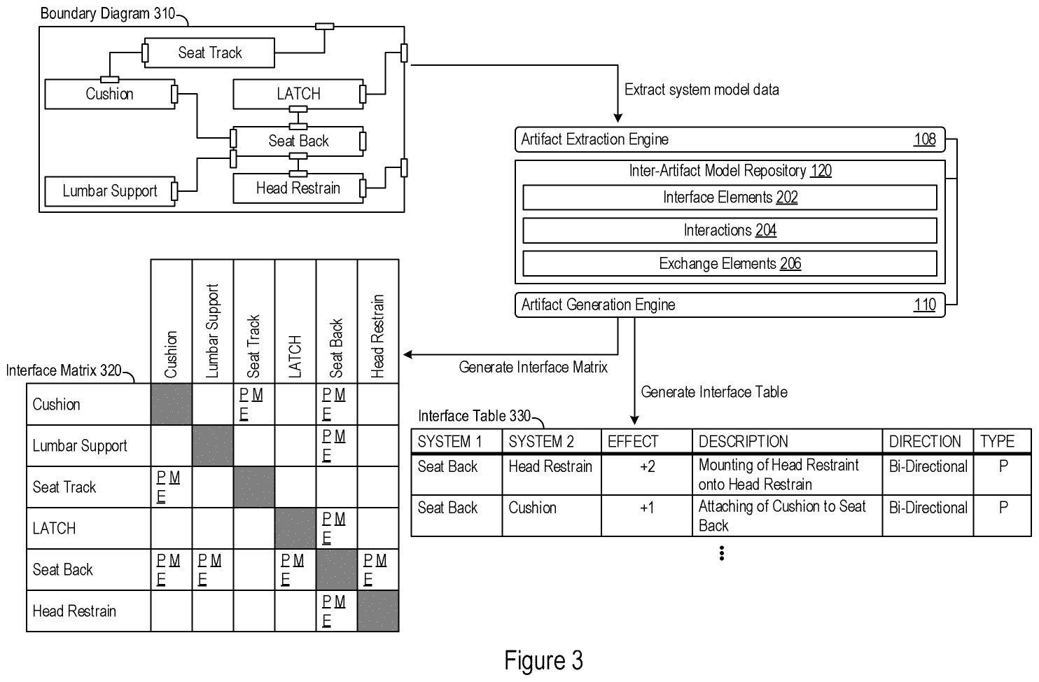

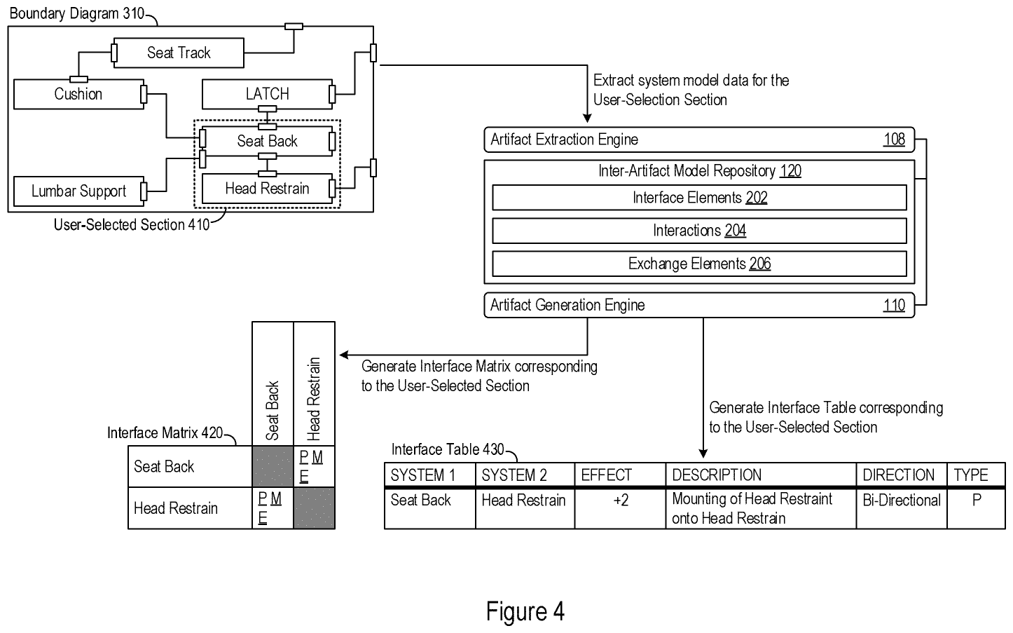

A system 100 may generate artifacts from system model data stored in an inter-artifact model repository 120, for example as described next through FIGS. 3 and 4.

FIG. 3 shows an example of inter-artifact generation. In FIG. 3, an artifact extraction engine 108 extracts selected system model data from a boundary diagram 310 to generate an interface matrix 320, an interface table 330, or both. The boundary diagram 310 may be user-created via a systems engineering tool, and the example boundary diagram 310 depicted in FIG. 3 includes system components of an automobile seat. In the particular example shown in FIG. 3, the boundary diagram 310 includes the system components labeled as “Cushion”, “Lumbar Support”, “Seat Track”, “LATCH”, “Seat Back”, and “Head Restrain”. Various interfaces and links are also shown in the boundary diagram 310.

To support inter-artifact generation, the artifact extraction engine 108 may extract system model data from the boundary diagram 310, including interface elements 202, interactions, 204, and exchange elements 206 specified in the boundary diagram 310. This specific system model data may form a selected subset of system model data present in the boundary diagram 310 that the artifact extraction engine 108 may pull to support inter-artifact generation of the interface matrix 320 or the interface table 330. For other artifact types (e.g., non-interface types), the artifact extraction engine 108 may extract additional or alternative forms of system model data present in the boundary diagram 310.

To support inter-artifact generation, the artifact generation engine 110 may generate a different system artifact that represents the automobile seat using at least some of the system model data extracted from the boundary diagram 310. As shown in FIG. 3, the artifact generation engine 110 may create an interface matrix 320 that uses matrix cells to depict interface relationships between the various system components of the automobile seat. Individual cells, cell symbols, rows, columns, or cell areas of the interface matrix 320 may be selectable by a user through operation of an input device (e.g., a mouse).

In some examples, a boundary diagram 310 may include hierarchical levels of system blocks (e.g., a system block being a subsystem with multiple subsystem components). To generate an interface matrix 320 from such a boundary diagram 310, the artifact generation engine 110 may expand the hierarchical levels of the boundary diagram 310 to obtain expanded system blocks, load interface elements 202 present in the expanded system blocks, loading interactions 204 between the loaded interface elements 202 present in the expanded system blocks, and create a cell in the interface matrix 320 for each loaded interaction 204. Due to the hierarchical nature of a boundary diagram 310, the artifact generation engine 110 may perform some of these operations in parallel or in bulk, to increase performance efficiencies.

As also shown in FIG. 3, the artifact generation engine 110 may generate an interface table 330 from a boundary diagram 310. Each row of the interface table 330 may represent a specific exchange element 206 between system components, and may include various interface information pulled from applicable interface elements 202, interactions 204, or the respective exchange elements 206. To generate the interface table 330, the artifact generation engine 110 may expand hierarchical levels of the boundary diagram 310 to obtain expanded system blocks, load interface elements 202 present in the expanded system blocks, load exchange elements 206 for interactions 204 between the loaded interface elements 202 present in the expanded system blocks, and create a row in the interface table 330 for each loaded exchange element 206.

FIG. 3 provides an example flow of inter-artifact generation in which an interface matrix 320 and interface table 330 are generated from a boundary diagram 310. Inter-artifact generation flows of any artifact permutations are supported by the artifact extraction engine 108 and artifact generation engine 110, for example generation of a boundary diagram 310 from a user-created interface matrix 320, generation of an interface matrix 320 from a user-created interface table 330, etc.

In some examples, inter-artifact generation is triggered via user interaction. For instance, the artifact extraction engine 108 may extract system model data responsive to identification of a user request to generate a different system artifact (e.g., an interface matrix or interface table). To illustrate, a user may interact with a user diagramming tool or other systems engineering tool to create, display, or otherwise modify the boundary diagram 310. During this process, the user may interact with the diagramming tool to select multiple system components in the boundary diagram 310 and provide a command (e.g., via selection of a menu item or other user interface feature) to display an interface matrix 320 or an interface table 330 artifact based on the manipulations made to the boundary diagram 310.

In such cases, the artifact extraction engine 108 may extract the system model data presently available from the boundary diagram 310 (or other user-created or active artifact that a user is viewing or modifying), store the extracted system model data in the inter-artifact model repository 120, and generate the requested system artifact via at least some of the extracted system model data. In some implementations, the artifact generation engine 110 may support visual presentation of a generated artifact (e.g., generated interface matrix 320) concurrently with the artifact from which the generated artifact was based on (e.g., the boundary diagram 310).

Subsequent edits or manipulations to any displayed system artifact (e.g., whether the boundary diagram 310, interface matrix 320, or interface table 330) may be identified by the artifact extraction engine 108 and relevant system model data may be extracted to store in the inter-artifact model repository 120. In that regard, the artifact extraction engine 108 may ensure a real-time state of a modeled system is tracked via the inter-artifact model repository 120 and the artifact generation engine 110 may update displayed system artifacts accordingly.

Through inter-artifact generation supported by the artifact extract engine 108 and artifact generation engine 110, various system artifacts can be consistently, efficiently, and accurately generated. Inter-artifact generation may support flexible swapping between different representations to support user inputs across different artifacts. Moreover, the ability to switch between various artifacts (e.g., the interface table 330, interface matrix 320, and/or boundary diagram 310) may enable systems to provide the ability to view complex data in a variety of ways, but with a consistent data set as stored in the inter-artifact model repository 120. Doing so may allow a user to identify a system gap or missing system aspect from a particular system artifact, update the modeled system accordingly, and propagate the update to the other representations as displayed through other generated artifacts.

FIG. 4 shows an example of inter-artifact generation based on a user-selected section of an artifact. User interaction may specify a selected portion of a system artifact, such as a boundary diagram 310. In FIG. 4, a user-selected section 410 is shown through user action to highlight specific system components, such as to specifically select the “Seat Back” and “Head Restrain” system blocks of the boundary diagram 310. The artifact extraction engine 108 and artifact generation engine 110 may support inter-artifact generation specifically for the user-selected section 410 of a system artifact.

In the example illustrated through FIG. 4, the artifact extraction engine 108 may extract system model data specifically for the user-selected section 410. In this instance, the artifact extraction engine 108 extracts interface-related system model data for the “Seat Back” and “Head Restrain” system blocks of the boundary diagram 310 and need not extract model system data for other system blocks not selected by the user. In this instance, the artifact generation engine 110 may generate different system artifacts that correspond to the user-selected section 410 of the boundary diagram 310.

As shown in FIG. 4, the artifact generation engine 110 may generate an interface matrix 420 that corresponds to the user-selected section 410 by including matrix cells representing interactions 204 between the “Seat Back” and “Head Restrain” system blocks, but not between other system blocks of the boundary diagram 310. In a similar manner, the artifact generation engine 110 may generate an interface table 430 that represents exchange elements 206 between the “Seat Back” and “Head Restrain” system blocks in particular, but not others of the boundary diagram 310. Such selective inter-artifact generation may allow a more nuanced or filtered view of system components, which may support user focus and modification of specific system elements. As noted above, changes to any represented artifact (e.g., the boundary diagram 310, interface matrix 420, or interface table 430) may be detected by the artifact extraction engine 108 and stored in the inter-artifact model repository 120 to provide a consistent view of a modeled system.

By providing a common repository to track and store system model data, the features described herein may promote increased efficiency and consistency in systems development and systems engineering. User-modifications or additions to system model data represented in a displayed artifact (e.g., a boundary diagram, interface matrix, and/or interface table) may be detected by the artifact extract engine 108, by which the artifact generation engine 110 may modify other (displayed) artifacts to consistently represent the modeled system. Thus, by unifying system model data storage in the inter-artifact model repository 120, the inter-artifact generation features described herein may provide various benefits in systems development.

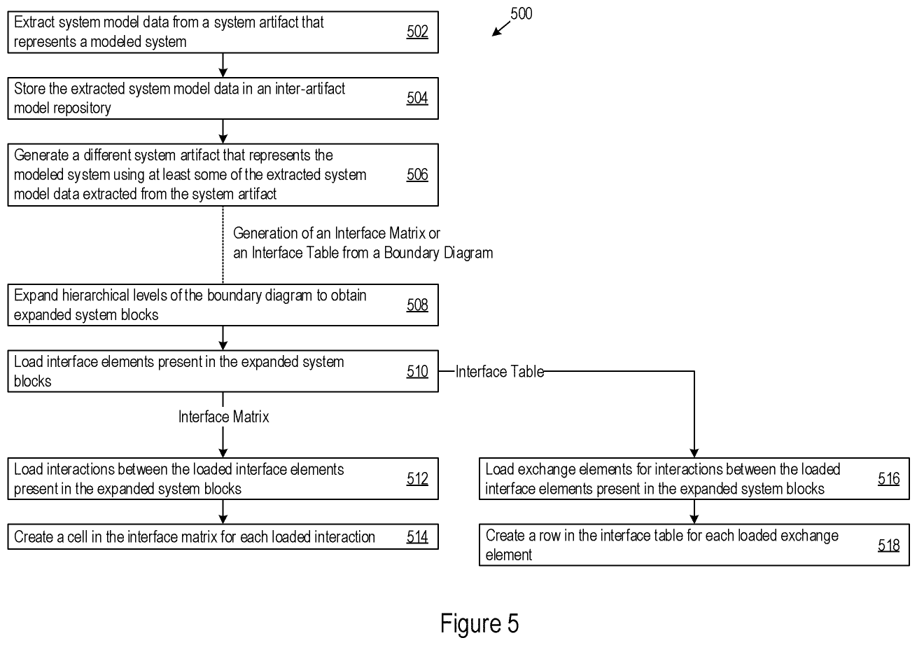

FIG. 5 shows an example of logic 500 that a system may implement to support inter-artifact generation for interfaces of a modeled system. In some examples, the system 100 may implement the logic 500 as hardware, executable instructions stored on a machine-readable medium, or as a combination of both. The system 100 may implement the logic 500 via the artifact extraction engine 108 and the artifact generation engine 110, through which the system 100 may perform or execute the logic 500 as a method to support inter-artifact generation for interfaces of a modeled system. The following description of the logic 500 is provided using the artifact extraction engine 108 and the artifact generation engine 110 as implementation examples. However, various other implementation options by a system are possible.

In implementing the logic 500, the artifact extraction engine 108 may extract system model data from a system artifact that represents a modeled system (502) and store the extracted system model data in an inter-artifact model repository 120 (504). In implementing the logic 500, the artifact generation engine 110 may generate a different system artifact that represents the modeled system using at least some of the extracted system model data extracted from the system artifact (506).

In some examples, the system artifact from which system model data is extracted from is a boundary diagram. In such examples, the artifact generation engine 110 may generate an interface matrix or an interface table from the boundary diagram. In some examples, the artifact generation engine 110 may expand hierarchical levels of the boundary diagram to obtain expanded system blocks (508). The artifact generation engine 110 may do so on a level-by-level basis (e.g., in bulk for system blocks of a level) until each hierarchical level has been expanded into system components. Then, the artifact generation engine 110 may load (e.g., access) interface elements 202 present in the expanded system blocks (510).

For generation of an interface matrix, the artifact generation engine 110 may load interactions 204 between the loaded interface elements 202 present in the expanded system blocks (512) and create a cell in the interface matrix for each loaded interaction 204 (514). For generation of an interface table, the artifact generation engine 110 may load exchange elements 206 for interactions 204 between the loaded interface elements 202 present in the expanded system blocks (516) and create a row in the interface table for each loaded exchange element (518).

While an example implementation is shown through FIG. 5, the logic 500 may include any number of additional or alternative steps as well. The logic 500 may additionally or alternatively implement any other inter-artifact generation features described herein, for example any with respect to the artifact extraction engine 108, the artifact generation engine 110, or a combination thereof.

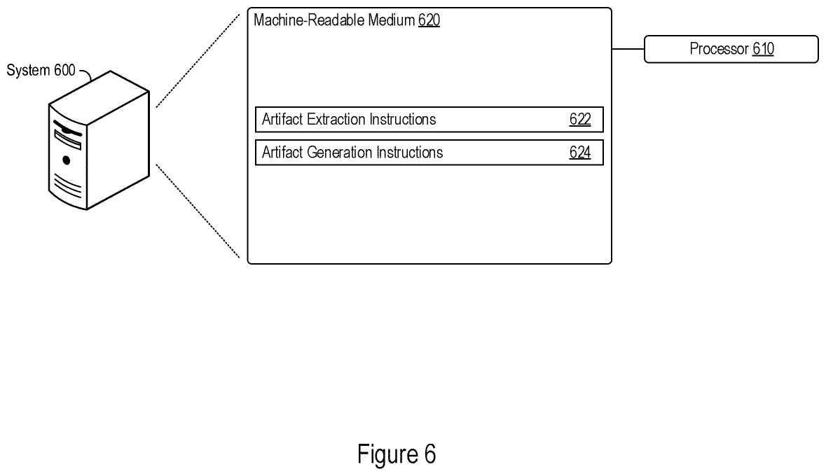

FIG. 6 shows an example of a system 600 that supports inter-artifact generation for interfaces of a modeled system. The system 600 may include a processor 610, which may take the form of a single or multiple processors. The processor(s) 610 may include a central processing unit (CPU), microprocessor, or any hardware device suitable for executing instructions stored on a machine-readable medium. The system 600 may include a machine-readable medium 620. The machine-readable medium 620 may take the form of any non-transitory electronic, magnetic, optical, or other physical storage device that stores executable instructions, such as the artifact extraction instructions 622 and artifact generation instructions 624 shown in FIG. 6. As such, the machine-readable medium 620 may be, for example, random access memory (RAM) such as a dynamic RAM (DRAM), flash memory, spin-transfer torque memory, an electrically-erasable programmable read-only memory (EEPROM), a storage drive, an optical disk, and the like.

The system 600 may execute instructions stored on the machine-readable medium 620 through the processor 610. Executing the instructions may cause the system 600 (or any other CAD, CAE, CAM, or systems engineering system) to perform any of the inter-artifact generation features described herein, including according to any of the features of the artifact extraction engine 108, the artifact generation engine 110, or combinations of both.

For example, execution of the artifact extraction instructions 622 by the processor 610 may cause the system 600 to extract system model data from a system artifact that represents a modeled system and store the extracted system model data in an inter-artifact model repository, including storage of interface elements that specify communication characteristics for system objects of the modeled system; interactions that represent a connection between system blocks of the modeled system; and exchange elements that specify particular functions and values communicated through the interactions. Execution of the artifact generation instructions 624 by the processor 610 may cause the system 600 to generate a different system artifact that represents the modeled system using at least some of the extracted system model data extracted from the system artifact.

The systems, methods, devices, and logic described above, including the artifact extraction engine 108 and the artifact generation engine 110, may be implemented in many different ways in many different combinations of hardware, logic, circuitry, and executable instructions stored on a machine-readable medium. For example, the artifact extraction engine 108, the artifact generation engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the artifact extraction engine 108, the artifact generation engine 110, or combinations of both.

The processing capability of the systems, devices, and engines described herein, including the artifact extraction engine 108 and the artifact generation engine 110, may be distributed among multiple system components, such as among multiple processors and memories, optionally including multiple distributed processing systems or cloud/network elements. Parameters, databases, and other data structures, such as the inter-artifact model repository 120, may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
through a computer system:
extracting system model data from a system artifact that represents a modeled system;
storing the extracted system model data in an inter-artifact model repository, including storing:
interface elements that specify communication characteristics for system objects of the modeled system;
interactions that represent a connection between system blocks of the modeled system; and
exchange elements that specify particular functions and values communicated through the interactions; and
generating a different system artifact that represents the modeled system using at least some of the extracted system model data extracted from the system artifact.

2. The method of claim 1, wherein extracting the system model data from the system artifact comprises extracting the system model data from a boundary diagram that represents the modeled system; and
wherein generating the different system artifact comprises generating an interface matrix or an interface table from the extracted system model data extracted from the boundary diagram.

3. The method of claim 2, wherein generating the interface matrix from the extracted system model data extracted from the boundary diagram comprises:
expanding hierarchical levels of the boundary diagram to obtain expanded system blocks;
loading interface elements present in the expanded system blocks;
loading interactions between the loaded interface elements present in the expanded system blocks; and
creating a cell in the interface matrix for each loaded interaction.

4. The method of claim 2, wherein generating the interface table from the extracted system model data extracted from the boundary diagram comprises:
expanding hierarchical levels of the boundary diagram to obtain expanded system blocks;
loading interface elements present in the expanded system blocks;
loading exchange elements for interactions between the loaded interface elements present in the expanded system blocks; and
creating a row in the interface table for each loaded exchange element.

5. The method of claim 1, comprising extracting the system model data from a user-selected section of the system artifact; and
generating the different system artifact to represent a portion of the modeled system that corresponds to the user-selected section of the system artifact.

6. A system comprising:
an inter-artifact model repository that stores system model data of a modeled system, wherein the system model data comprises:
interface elements that specify communication characteristics for system objects of the modeled system;
interactions that represent a connection between system blocks of the modeled system; and
exchange elements that specify particular functions and values communicated through the interactions; and
an artifact extraction engine configured to:
extract system model data from a system artifact that represents the modeled system; and
store the extracted system model data in the inter-artifact model repository; and
an artifact generation engine configured to generate a different system artifact that represents the modeled system using at least some of the extracted system model data extracted from the system artifact.

7. The system of claim 6, wherein the artifact extraction engine is configured to extract the system model data from a boundary diagram that represents the modeled system; and
wherein the artifact generation engine is configured to generate an interface matrix or an interface table from the extracted system model data extracted from the boundary diagram.

8. The system of claim 7, wherein the artifact generation engine is configured to generate the interface matrix from the extracted system model data extracted from the boundary diagram by, at least in part:
expanding hierarchical levels of the boundary diagram to obtain expanded system blocks;
loading interface elements present in the expanded system blocks;
loading interactions between the loaded interface elements present in the expanded system blocks; and
creating a cell in the interface matrix for each loaded interaction.

9. The system of claim 7, wherein the artifact generation engine is configured to generate the interface table from the extracted system model data extracted from the boundary diagram by, at least in part:
expanding hierarchical levels of the boundary diagram to obtain expanded system blocks;
loading interface elements present in the expanded system blocks;
loading exchange elements for interactions between the loaded interface elements present in the expanded system blocks; and
creating a row in the interface table for each loaded exchange element.

10. The system of claim 6, wherein the artifact extraction engine is configured to extract the system model data from a user-selected section of the system artifact; and
wherein the artifact generation engine is configured to generate the different system artifact to represent a portion of the modeled system that corresponds to the user-selected section of the system artifact.

11. The system of claim 6, wherein the artifact extraction engine is configured to extract the system model data from an interface matrix that represents the modeled system; and
wherein the artifact generation engine is configured to generate a boundary diagram or an interface table from the extracted system model data extracted from the interface matrix.

12. A non-transitory machine-readable medium storing instructions that, when executed by a processor, cause a system to:
extract system model data from a system artifact that represents a modeled system;
store the extracted system model data in an inter-artifact model repository, including storage of:
interface elements that specify communication characteristics for system objects of the modeled system;
interactions that represent a connection between system blocks of the modeled system; and
exchange elements that specify particular functions and values communicated through the interactions; and
generate a different system artifact that represents the modeled system using at least some of the extracted system model data extracted from the system artifact.

13. The non-transitory machine-readable medium of claim 12, wherein the instructions to extract the system model data from the system artifact comprise instructions that cause the system to extract the system model data from a boundary diagram that represents the modeled system; and
wherein the instructions to generate the different system artifact comprise instructions that cause the system to generate an interface matrix or an interface table from the extracted system model data extracted from the boundary diagram.

14. The non-transitory machine-readable medium of claim 13, wherein the instructions to generate the interface matrix from the extracted system model data extracted from the boundary diagram comprise instructions that cause the system to:
expand hierarchical levels of the boundary diagram to obtain expanded system blocks;
load interface elements present in the expanded system blocks;
load interactions between the loaded interface elements present in the expanded system blocks; and
create a cell in the interface matrix for each loaded interaction.

15. The non-transitory machine-readable medium of claim 13, wherein the instructions to generate the interface table from the extracted system model data extracted from the boundary diagram comprise instructions that cause the system to:
expand hierarchical levels of the boundary diagram to obtain expanded system blocks;
load interface elements present in the expanded system blocks;
load exchange elements for interactions between the loaded interface elements present in the expanded system blocks; and
create a row in the interface table for each loaded exchange element.

16. The non-transitory machine-readable medium of claim 12, wherein the instructions, when executed, cause the system to extract the system model data from a user-selected section of the system artifact; and
generate the different system artifact to represent a portion of the modeled system that corresponds to the user-selected section of the system artifact.

17. The non-transitory machine-readable medium of claim 12, wherein the instructions, when executed, cause the system to extract the system model data from an interface matrix that represents the modeled system; and
generate a boundary diagram or an interface table from the extracted system model data extracted from the interface matrix.
